(19) United States
(12) Patent Application Publication
(10) Pub. No.: US 2018/0089190 A1
(43) Pub. Date: Mar. 29, 2018

(54) Method of Generating and Intermingling Media Playlists from User Submitted Search Terms by Executing Computer-Executable Instructions Stored On a Non-Transitory Computer-Readable Medium

(71) Applicant: Sam Golden, Brooklyn, NY (US)

(72) Inventor: Sam Golden, Brooklyn, NY (US)

(21) Appl. No.: 15/279,713

(22) Filed: Sep. 29, 2016

(51) Int. Cl. G06F 17/30; H04L 29/06

(52) U.S. Cl. CPC G06F 17/30038; H04L 67/42; H04L 67/02; G06F 17/30598; G06F 17/30053

(57) ABSTRACT

A method of generating and intermingling media playlists from user submitted search terms generates playlists of media elements, such as videos, from user-submitted category keywords and intermingles the media elements from the categories into a single playlist. Multiple media elements from multiple categories can be displayed concurrently. A database server is searched with each received category keyword in order to find a plurality of matching media elements for each category keyword. A corresponding playlist is generated for each category keyword from the matching media elements of each category keyword. The matching media elements for each corresponding playlist are intermingled amongst each other in order to compile a current playlist. The current media elements of the current playlist are sequentially displayed on the display device, and multiple current media elements are displayed concurrently, if a concurrent media command is received from the user.

### FIELD OF THE INVENTION

The present invention relates generally to digital media. More particularly, the present invention relates to generating and displaying playlists of digital media elements concurrently.

### BACKGROUND OF THE INVENTION

Entertainment is a form of activity that holds the attention and interest of an audience and gives pleasure, delight or other stimulating results. The importance of entertainment is recognized by scholars, and psychologists say the function of media entertainment is the attainment of gratification. The experience of being entertained has come to be strongly associated with amusement, so that one common understanding of the idea is fun and laughter, although many entertainments have a serious purpose. This may be the case in the various forms of ceremony, celebration, religious festival, or satire for example. Hence, there is the possibility that what appears as entertainment may also be a means of achieving insight or intellectual growth. Although individuals have different preferences in entertainment, most forms are recognizable and familiar. Many forms of entertainment exist, such as storytelling, music, drama, dance, and different kinds of performance, and entertainment is pervasive throughout all cultures. Other forms of entertainment include games, reading, comedy, cinema and film, magic, parades, fireworks, sport, fairs, and shopping.

While entertainment has, for all intents and purposes, existed throughout recorded human history, in forms such as storytelling, entertainment had evolved into a plethora of forms in the modern age. One particularly extensive and commonplace form of modern entertainment is digital media. Media is defined as the collective communication outlets or tools that are used to store and deliver information or data. Digital media in particular includes any media that is encoded in a machine-readable format, or a format than can be understood by a computer. Digital media can be created, viewed, distributed, modified and preserved on digital electronics devices. Examples of digital media include computer programs and software, digital imagery, digital video, video games, web pages and websites, data and databases, digital audio, and e-books.

In the years since the development of the first digital computers, computing power and storage capacity have increased exponentially. Personal computers and smartphones put the ability to access, modify, store and share digital media in the hands of billions of people. Many electronic devices have the ability to create, transmit and view digital media. Combined with the world wide web and the internet, digital media has transformed modern society in a way that is frequently compared to the cultural, economic and social impact of the printing press. The change has been so rapid and so widespread that it has launched an economic transition from an industrial economy to an information-based economy, creating a new period in human history known as the Information Age or the Digital Revolution. Digital media has also allowed individuals to be much more active in content creation. Anyone with access to computers and the Internet can participate in social media and contribute their own writing, art, videos, photography and commentary to the Internet, as well as conduct business online. This has come to be known as citizen journalism. This spike in user created content is due to the development of the Internet as well as the way in which users interact with media today. The release of technologies such mobile devices allow for easier and quicker access to all things media. Many media production tools that were once only available to a few are now free and easy to use. The cost of devices that can access the internet is dropping steadily, and now personal ownership of multiple digital devices is becoming standard.

Consumption of digital media, particularly viewing digital videos and listening to digital audio such as music, podcasts or lectures, is a particularly ubiquitous form of entertainment in modern society. In addition to watching television, individuals commonly consume large quantities of digital media through their personal computers and other electronic devices such as smartphones and tablets. Due to the enormous library of content stored on the internet, virtually any type, subject, or other category of digital media is available to the individual to consume.

Currently, many services exist to serve digital media to the user. Some services provide the ability for the user to view media elements such as videos individually, or to create playlists of media elements. Other services generate a playlist of media elements that is delivered to the user sequentially. Other services provide the ability to view multiple videos simultaneously on the same interface. However, there does not exist a service that provides the combination of the aforementioned capabilities. It is therefore an objective of the present invention to provide a method for implementing a media player software application wherein a user can search for multiple keywords, a playlist is automatically generated for each of the keywords, the playlists are intermingled, and media elements can be delivered to the user concurrently. The user can search for multiple keywords and playlists for each of the keywords will be delivered to the user simultaneously.

### BRIEF DESCRIPTION OF THE DRAWINGS

FIG. 1 is a system diagram showing the general operation of the present invention.

FIG. 2 is a stepwise flow diagram describing the general method of the present invention.

FIG. 3 is a stepwise flow diagram describing a step for finding matching media elements.

FIG. 4 is a stepwise flow diagram describing steps for adding a new category to the current playlist.

FIG. 5 is a stepwise flow diagram describing steps for removing a category from the current playlist.

FIG. 6 is a stepwise flow diagram describing steps for defining and utilizing an intermingling algorithm to create the current playlist.

FIG. 7 is a stepwise flow diagram describing steps for adding user media elements to the media server.

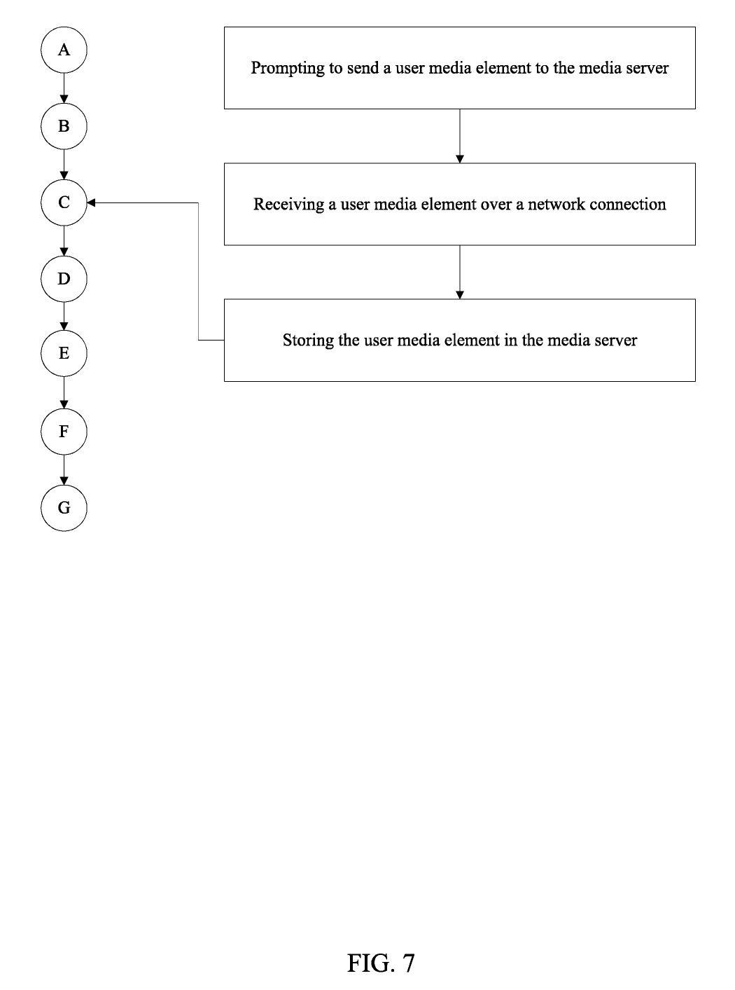

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

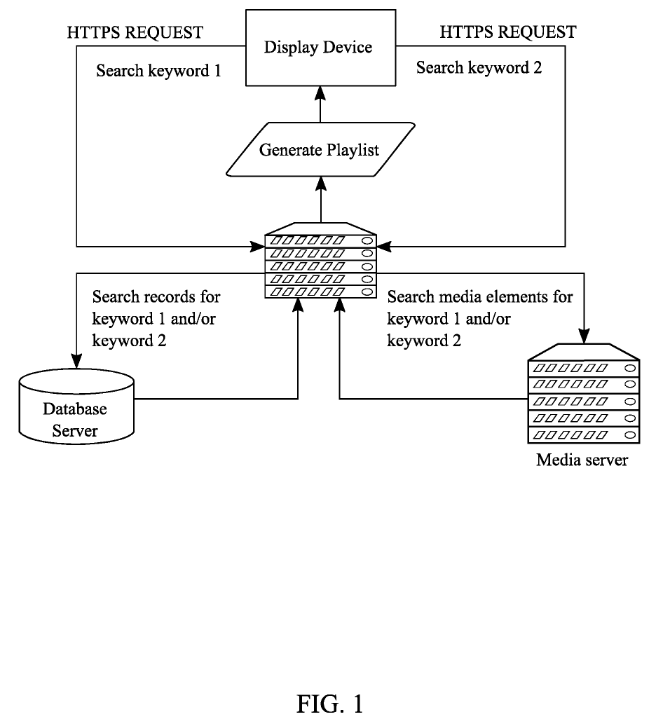

The present invention is a method for implementing a media player software application that can search for, display, and intermingle multiple categories of media to play in a sequential list format, as well as concurrently. A general system diagram is shown in FIG. 1. The present invention is a media player and search engine that allows user to search and display multiple categories of media at the same time. For example, the user may search for a first category, such as a specific musical artist, a specific musical genre, or videos on subjects such as stocks, sports, weather, or any other available category of digital media. The present invention searches for relevant media and compiles the relevant media into a playlist. While the playlist is running, the user may enter additional desired categories to view, and the results from the search for the new categories will be added to the playlist from the initial search. Multiple media categories can be played concurrently from different playlists. The present invention allows users to consume media from multiple categories such as different sports teams, weather, traffic, comedy, music and other categories, at the same time or sequentially. Media elements used by the present invention may be, but are not limited to, video files, audio files, documents, or any other type of media which may be relevant. However, the general focus of the present invention is on videos and audio such as comedy, podcasts or music.

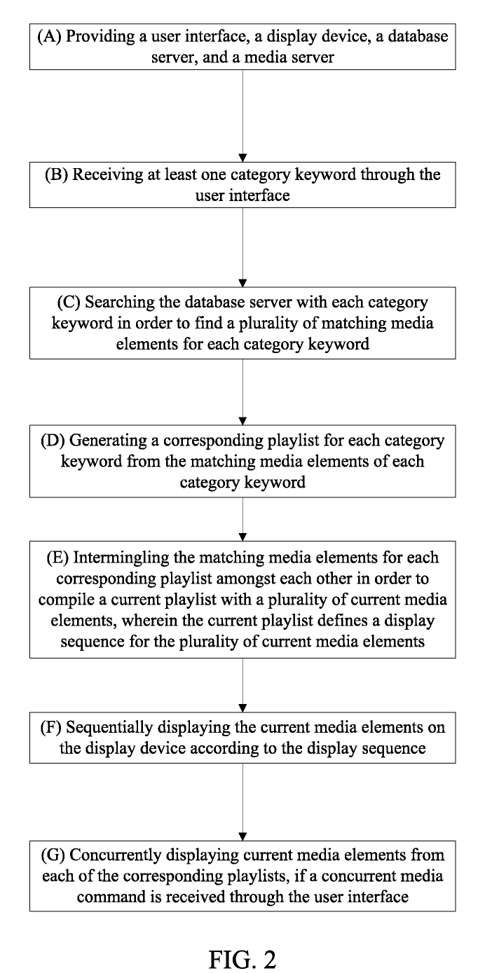

Referring to FIG. 2, in the general method of the present invention, a user interface is provided, in addition to a display device, a database server and a media server. The user interface and the display device constitute a user device with which the user interacts in order to take advantage of the services provided by the present invention. The user interface and the display device can be separate devices that are connected together to form a functional unit. The present invention may further comprise any computing or other electronic elements which are necessary or desired in the implementation of the present invention, and the computing components which operate the present invention may be communicably coupled to each other through any means, such as, but not limited to, wireless data networks, local area networks, wired connections, or any other means for electronic communication. Various computing processes of the present invention may be executed by various computing elements of the present invention as applicable to the implementation of the present invention. For example, some computing processes may be carried out locally on the user device, and the results communicated to a master remote server operating the present invention, and vice versa.

The user interface should be understood to be herein any means through which an end user can interact with the present invention. The user interface allows the user to input information in order to perform searches and modify playlists. In one embodiment of the present invention, the user interface may be any physical input-output device through which the user can enter commands to the system, such as, but not limited to, a keyboard, a mouse, or another type of input device. In one embodiment, the user interface is a digital touchscreen interface, such as, but not limited to, a touchscreen of a mobile smartphone, a tablet touchscreen, or another type of touchscreen that the user interacts with using their fingers, a stylus or any other relevant physical apparatus to produce inputs to the touchscreen sensing element.

The display device is an electronic component capable of receiving digital or analog signals in order to produce a visual output, such as, but not limited to, a television, a computer monitor, a smartphone, a tablet, or any other relevant device which can facilitate displaying media. An audio output device should also be included in the system of the present invention in order to allow the user to hear audio accompanying videos or other media elements. As previously mentioned, in some embodiments the user interface and the display device are bundled in a user device that is a singular unit. The user device may be, but is not limited to, a laptop computer, a smartphone, a desktop computer, a tablet computer, or another type of personal computing device.

The database server is a physical computer processing element that stores any relevant digital information as a database. The database server may be a local server or a remote server, and may be operated by any relevant entity, but in general, the database server will be operated by the organization that provides the present invention as a service to the user. Any relevant information may be stored on the database server, such as, but not limited to, records of media elements. The media server is similarly a physical computer processing element that stores information. The media server stores media files that can be retrieved in the present invention in order to present to the user. The present invention may retrieve media elements from the media server in order to display to the user, or the present invention may reference media elements from third party media servers.

When the user wishes to generate a playlist, the user initiates a search through the user interface by inputting a category keyword into a search engine, thus, at least one category keyword is received through the user interface. The search request is sent to a web server, and the search engine script attempts to connect to the database server. Once the connection to the database server is established, the database is queried to find all the data and records that match the category keyword.

The database server is searched with the category keywords in order to determine where the relevant media elements are in order to retrieve them. If relevant records are found, the search engine then connects to the media server in order to retrieve a virtual address of each relevant media element.

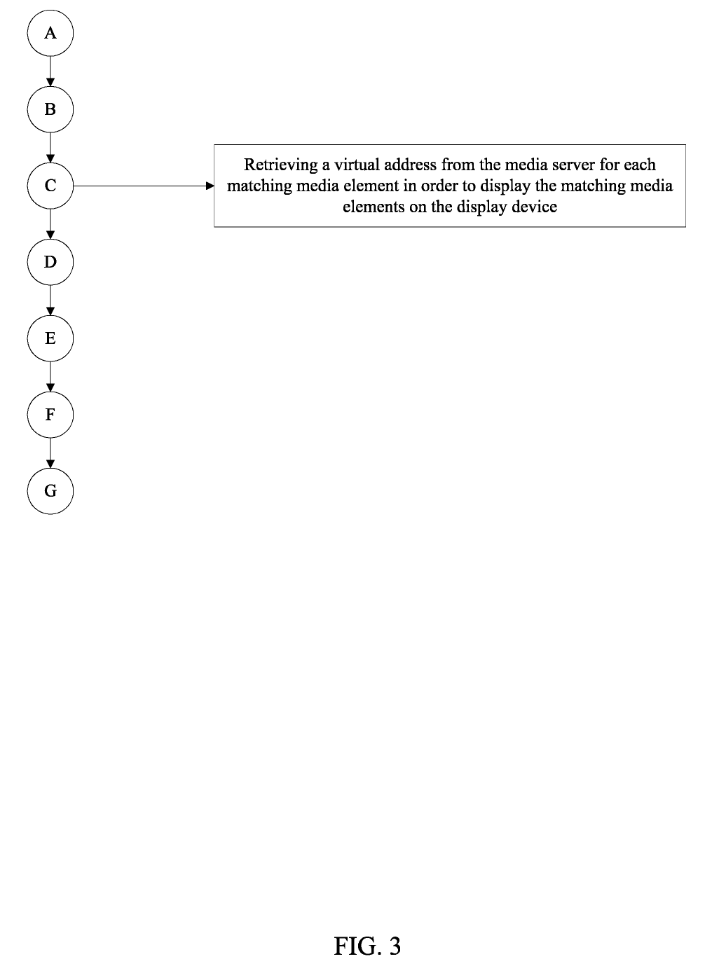

The database server is searched with the category keyword in order to find a plurality of matching media elements for each category keyword. The user may search for a single category, or multiple categories simultaneously, or multiple categories subsequently which are intermingled with any previously searched categories. In some embodiments, a virtual address is retrieved from the media server for each matching media element in order to display the matching media elements on the display device, as shown in FIG. 3. A corresponding playlist is generated for each category keyword from the matching media elements of each category keyword. The corresponding playlists for each of the category keywords are then intermingled with each other in order to compile a current playlist with a plurality of media elements, wherein the current playlist defines a display sequence for the plurality of current media elements. The current media elements are the grouping of all matching media elements for all the category keywords that were searched for. The current media elements are then sequentially displayed on the display device according to the display sequence.

In the preferred embodiment of the present invention, the current playlist is generated in JavaScript Object Notation (JSON) format. However, it is contemplated that any relevant format, programming language, markup language or combination thereof may be utilized to implement the present invention, such as, but not limited to, YAML, XML, HTML, JavaScript, Java, Python, CSS, PHP, XHP, Ruby, Go, C, or C++.

The user has the option in the present invention to view only a single current media element from the current playlist at a time, or the user may desire to view multiple current media elements at the same time. The user may input a concurrent media command through the user interface in order to display multiple current media elements concurrently. If a concurrent media command is received through the user interface, current media elements from each of the corresponding playlists that make up the current playlist are displayed concurrently on the display device. Thus, the user is able to watch multiple videos at the same time from different categories. For example, the user may choose to watch sports videos, music videos, and stocks videos at the same time.

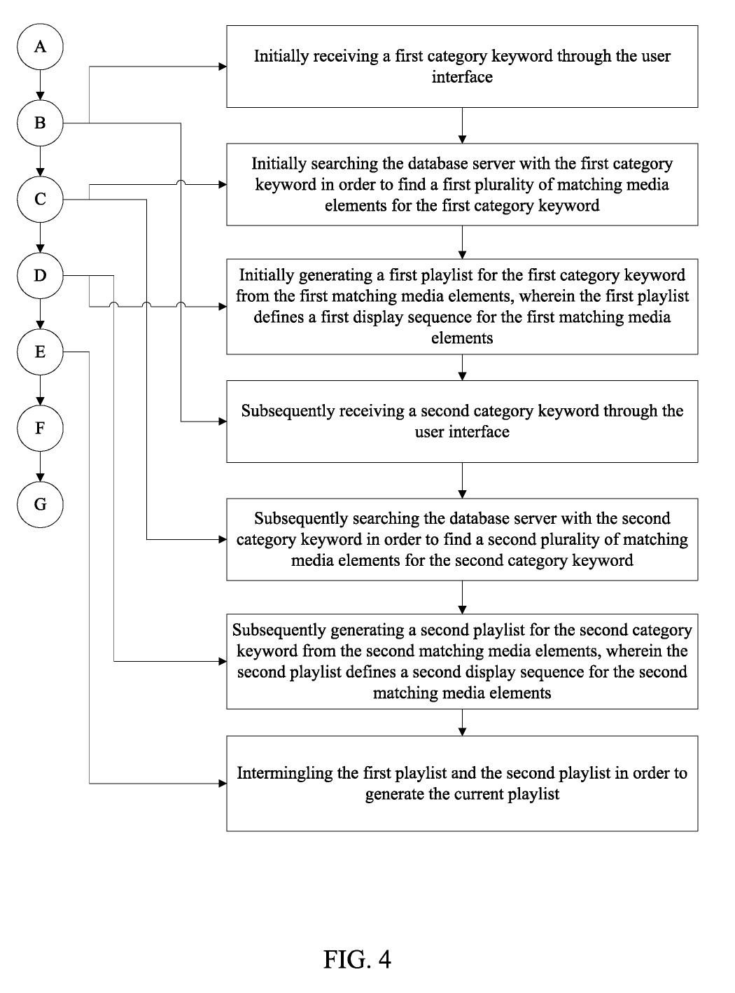

As described in FIG. 4, the process for creating an intermingled playlist from two subsequent category keywords, wherein the second category keyword is searched after the first category keyword, is as follows. The user initially inputs a first category keyword through the user interface, which is received by the system. The database server is initially searched with the first category keyword in order to find a first plurality of matching media elements for the first category keyword, and a first playlist is initially generated for the first category keyword from the first matching media elements, wherein the first playlist defines a first display sequence for the first matching media elements. The first matching media elements are then displayed on the display device according to the first playlist. The user then decides to add a second category to their viewing experience. Subsequently, the process is repeated, and a second category keyword is received through the user interface. The database server is subsequently searched with the second category keyword in order to find a second plurality of matching media elements for the second category keyword. A second playlist is subsequently generated for the second category keyword from the second matching media elements, wherein the second playlist defines a second display sequence for the second matching media elements. The first playlist and the second playlist are then intermingled in order to generate the current playlist. This process may be repeated as many times as desired by the user in order to concurrently display many different categories of media.

In the preferred embodiment of the present invention, the user has the option to perform searches for categories one at a time, or the user may search for multiple categories simultaneously by entering a plurality of category keywords in the search engine text field. The search engine script will generate the corresponding playlists for each of the plurality of category keywords entered and subsequently intermingle the corresponding playlists into the current playlist.

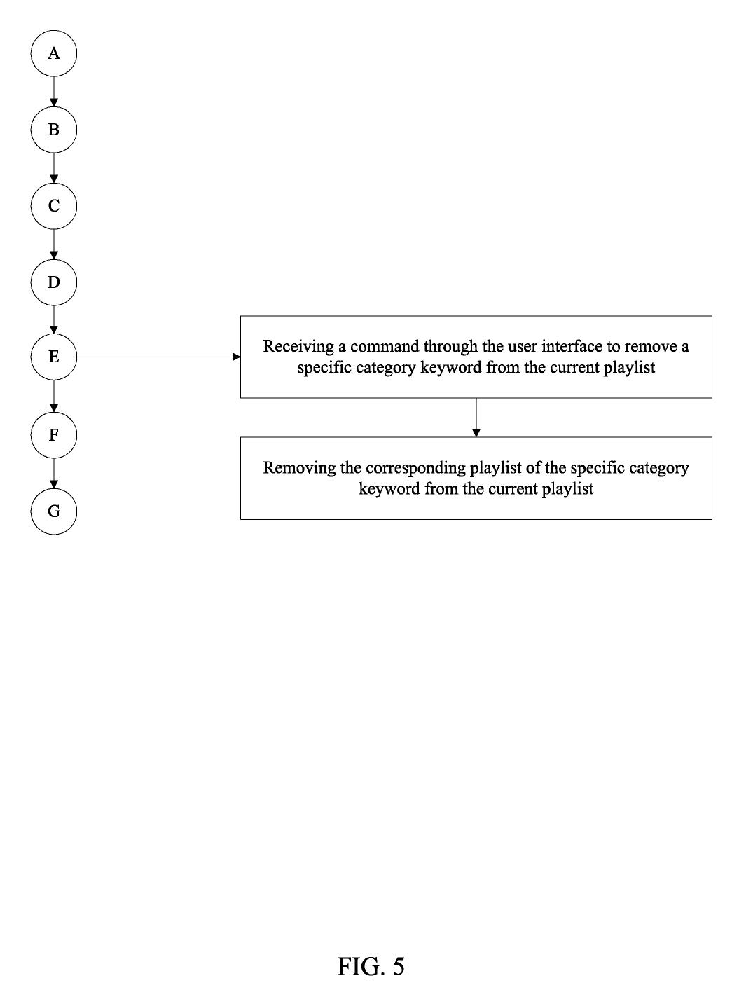

Furthermore, the user may remove a category from the current playlist, as shown in FIG. 5. Thus, if a command is received through the user interface to remove a specific category keyword from the current playlist, the media elements of the corresponding playlist of the specific category keyword are removed from the current media elements of the current playlist.

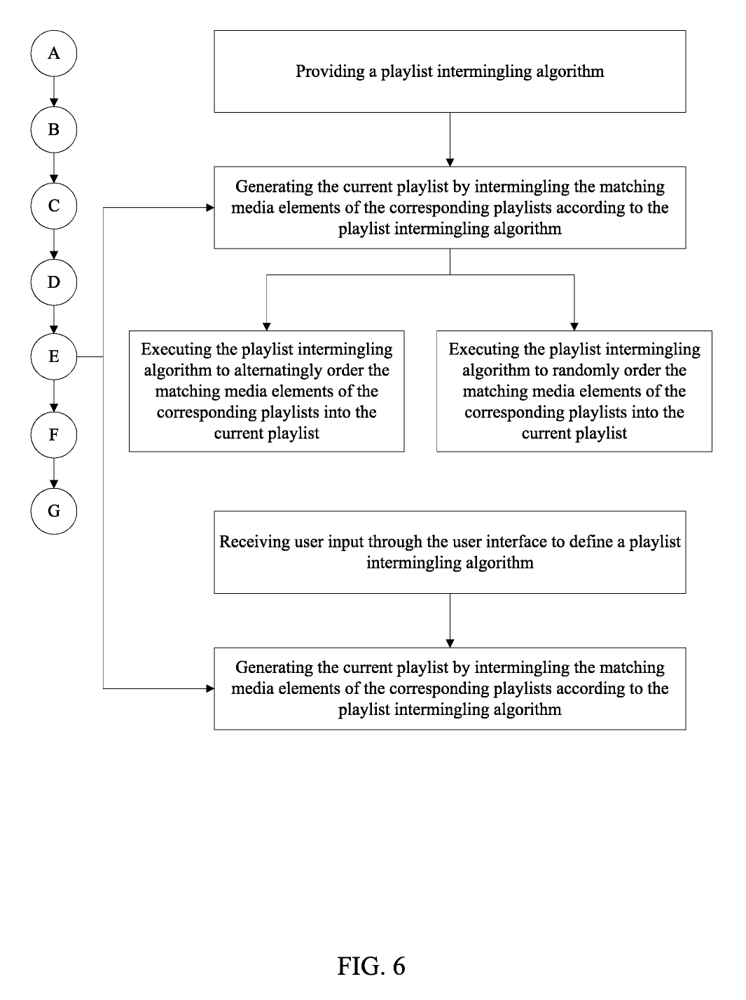

Referring to FIG. 6, in the preferred embodiment of the present invention, the media elements corresponding to the searched category keywords are intermingled through a playlist intermingling algorithm, and the current playlist is generated by intermingling the matching media elements of the corresponding playlists of the category keywords according to the playlist intermingling algorithm. In one embodiment, the playlist intermingling algorithm is executed to alternatingly order the matching media elements of the corresponding playlists into the current playlist. Thus, for example, given two corresponding playlists A and B, the current playlist would display the current media elements according to the algorithm ABABAB and so on. Similarly, given three playlists A, B, and C, the current playlist would display the current media elements according to the algorithm ABCABCABC.

In one embodiment, the playlist intermingling algorithm is executed to randomly order the matching media elements of the corresponding playlists into the current playlist. Thus, given four playlists A, B, C, and D, the algorithm might look, for example, DACACBBDABCA, or DDBADBCBACBC. It is further contemplated that data analytics techniques may be utilized to weight media elements with certain characteristics that change their position in the current playlist. For example, shorter videos, newer videos, or more popular videos may be given priority in the current playlist. Furthermore, in one embodiment, the user is able to modify the current playlist according to their preference. The user may wish to see more sports videos than weather videos, for example. Thus, user input may be received through the user interface to define the playlist intermingling algorithm, or to modify the playlist intermingling algorithm. This can be accomplished through a number of means. For example, the user may assign a priority ranking to each category keyword, or the user may define a ratio of media elements displayed from one category keyword to another category keyword. The current playlist is then generated by intermingling the matching media elements of the corresponding playlists of the category keywords according to the playlist intermingling algorithm.

In one embodiment, users are permitted to submit their own media elements to add to the media server. For example, musical artists may upload their songs and music videos, and animators, video bloggers and many other content creators may add their media to the present invention to be included in searches for category keywords. This can aid the content creators in growing their viewership and business. In one embodiment, only verified content creators may be allowed to upload media elements, and verified credentials must be presented in order to initiate the upload process. In other embodiments, any users are permitted to upload media elements. In order to upload a media element, the user may be presented with an upload interface, through which the user is prompted to send a user media element to the media server. The user interacts with the upload interface to choose a file from their local data storage, from a connected cloud storage, or another permitted data source, and initiates the transfer to the media server of the present invention over a network connection. Once the user media element is received over the network connection, the user media element is processed and stored in the media server and is ready to be retrieved as part of a category keyword search.

Although the invention has been explained in relation to its preferred embodiment, it is to be understood that many other possible modifications and variations can be made without departing from the spirit and scope of the invention as hereinafter claimed.

What is claimed is:

1. A method of generating and intermingling media playlists from user submitted search terms by executing computer-executable instructions stored on a non-transitory computer-readable medium comprises the steps of:
providing a user interface, a display device, a database server, and a media server;
receiving at least one category keyword through the user interface;
searching the database server with each category keyword in order to find a plurality of matching media elements for each category keyword;
generating a corresponding playlist for each category keyword from the matching media elements of each category keyword;
intermingling the matching media elements for each corresponding playlist amongst each other in order to compile a current playlist with a plurality of current media elements, wherein the current playlist defines a display sequence for the plurality of current media elements;
sequentially displaying the current media elements on the display device according to the display sequence; and
concurrently displaying current media elements from each of the corresponding playlists on the display device, if a concurrent media command is received through the user interface.

2. The method of generating and intermingling media playlists from user submitted search terms by executing computer-executable instructions stored on a non-transitory computer-readable medium as claimed in claim 1 comprises the steps of:
initially receiving a first category keyword through the user interface;
initially searching the database server with the first category keyword in order to find a first plurality of matching media elements for the first category keyword;
initially generating a first playlist for the first category keyword from the first matching media elements, wherein the first playlist defines a first display sequence for the first matching media elements;
subsequently receiving a second category keyword through the user interface;
subsequently searching the database server with the second category keyword in order to find a second plurality of matching media elements for the second category keyword;
subsequently generating a second playlist for the second category keyword from the second matching media elements, wherein the second playlist defines a second display sequence for the second matching media elements; and
intermingling the first playlist and the second playlist in order to generate the current playlist.

3. The method of generating and intermingling media playlists from user submitted search terms by executing computer-executable instructions stored on a non-transitory computer-readable medium as claimed in claim 1 comprises the steps of:
receiving a command through the user interface to remove a specific category keyword from the current playlist; and
removing the corresponding playlist of the specific category keyword from the current playlist.

4. The method of generating and intermingling media playlists from user submitted search terms by executing computer-executable instructions stored on a non-transitory computer-readable medium as claimed in claim 1 comprises the step of:
retrieving a virtual address from the media server for each matching media element in order to display the matching media elements on the display device.

5. The method of generating and intermingling media playlists from user submitted search terms by executing computer-executable instructions stored on a non-transitory computer-readable medium as claimed in claim 1 comprises the steps of:
providing a playlist intermingling algorithm; and
generating the current playlist by intermingling the matching media elements of the corresponding playlists according to the playlist intermingling algorithm.

6. The method of generating and intermingling media playlists from user submitted search terms by executing computer-executable instructions stored on a non-transitory computer-readable medium as claimed in claim 5 comprises the step of:
executing the playlist intermingling algorithm to alternatingly order the matching media elements of the corresponding playlists into the current playlist.

7. The method of generating and intermingling media playlists from user submitted search terms by executing computer-executable instructions stored on a non-transitory computer-readable medium as claimed in claim 5 comprises the step of:
executing the playlist intermingling algorithm to randomly order the matching media elements of the corresponding playlists into the current playlist.

8. The method of generating and intermingling media playlists from user submitted search terms by executing computer-executable instructions stored on a non-transitory computer-readable medium as claimed in claim 1 comprises the steps of:
receiving user input through the user interface to define a playlist intermingling algorithm; and
generating the current playlist by intermingling the matching media elements of the corresponding playlists according to the playlist intermingling algorithm.

9. The method of generating and intermingling media playlists from user submitted search terms by executing computer-executable instructions stored on a non-transitory computer-readable medium as claimed in claim 1 comprises the steps of:
prompting to send a user media element to the media server;
receiving a user media element over a network connection; and
storing the user media element in the media server.
